(19) United States
(12) Patent Application Publication
(10) Pub. No.: US 2025/0187669 A1
(43) Pub. Date: Jun. 12, 2025

(54) VEHICLE FLOOR FRAME

(71) Applicants: Hyundai Motor Company, Seoul (KR); Kia Corporation, Seoul (KR)

(72) Inventor: Jong Min Kim, Hwaseong-si (KR)

(21) Appl. No.: 18/883,304

(22) Filed: Sep. 12, 2024

(30) Foreign Application Priority Data
Dec. 8, 2023 (KR) 10-2023-0178080

(51) Int. Cl. B62D 21/15; B62D 21/03

(52) U.S. Cl. CPC B62D 21/152; B62D 21/03

(57) ABSTRACT

An embodiment vehicle floor frame includes a center frame, a rear frame disposed behind the center frame, a connection unit connecting the center frame and the rear frame, a pair of support frames disposed on both sides of the connection unit between the center frame and the rear frame, a front load member connecting the center frame and a front portion of the connection unit, and a rear load member connecting the rear frame and a rear portion of the connection unit.

### CROSS-REFERENCE TO RELATED APPLICATIONS

This application claims the benefit of Korean Patent Application No. 10-2023-0178080, filed on Dec. 8, 2023, which application is hereby incorporated herein by reference in its entirety.

### TECHNICAL FIELD

The present disclosure relates to a vehicle floor frame.

### BACKGROUND

A bus may include a door for ingress and egress of passengers and a ramp allowing easy access for wheelchairs and the like.

In recent years, a median bus lane (or center transit lane) system has been introduced to improve punctuality and speedy transit of public transportation. When the median bus lane system is operated, it may be expected that travel time of existing routes may be significantly reduced.

Meanwhile, when the median bus lane system is introduced, island-type bus stops need to be applied. When the island-type bus stops are applied, road environmental efficiency and convenient ingress and egress of passengers may be improved. In response to the application of the island-type bus stops, the bus may need to have a pair of doors provided on both left and right sides to open and close individually and a pair of ramps individually corresponding to the pair of doors. The pair of doors may be disposed to face each other with respect to a central longitudinal axis of a vehicle body, and the pair of ramps may be disposed on a floor frame of the vehicle to face each other with respect to a central longitudinal axis of the floor frame. Since each ramp is not a stiffness member and portions of the vehicle floor frame need to be removed when the pair of ramps are mounted on the vehicle floor frame, stiffness of the vehicle body may be significantly reduced. Thus, the vehicle body having the pair of facing doors and the pair of facing ramps may have relatively reduced stiffness.

The above information described in this background section is provided to assist in understanding the background of the inventive concept, and it may include any technical concept which is not considered as the already known prior art.

### SUMMARY

The present disclosure relates to a vehicle floor frame. Particular embodiments relate to a vehicle floor frame designed to improve stiffness of a vehicle body.

Embodiments of the present disclosure can solve problems occurring in the prior art while advantages achieved by the prior art are maintained intact.

An embodiment of the present disclosure provides a vehicle floor frame designed to improve stiffness of a vehicle body having a pair of facing doors and a pair of facing ramps.

According to an embodiment of the present disclosure, a vehicle floor frame may include a center frame, a rear frame located behind the center frame, a connection unit connecting the center frame and the rear frame, a pair of support frames disposed on both sides of the connection unit, a front load member connecting the center frame and a front portion of the connection unit, and a rear load member connecting the rear frame and a rear portion of the connection unit, wherein the pair of support frames are disposed between the center frame and the rear frame.

The connection unit may include a pair of structural members aligned with a central longitudinal axis of the center frame and a central longitudinal axis of the rear frame.

The connection unit may further include a reinforcing member interposed between the pair of structural members.

The pair of support frames may be connected to the pair of structural members, respectively.

The center frame may include a main crossmember and an end crossmember located behind the main crossmember. A front end of each structural member may be fixed to a central portion of the end crossmember of the center frame.

Two front load members may connect the main crossmember of the center frame and the end crossmember of the center frame. Rear ends of the two front load members may be aligned with the front ends of the pair of structural members.

One front load member may connect the main crossmember of the center frame and the end crossmember of the center frame. A front end of the front load member may be fixed to a central portion of the main crossmember of the center frame, and a rear end of the front load member may be fixed to the central portion of the end crossmember of the center frame.

The front load member may include a pair of front expanded portions symmetrically provided on a front portion thereof and a pair of rear expanded portions symmetrically provided on a rear portion thereof.

The rear frame may include a main crossmember and an end crossmember located in front of the main crossmember. A rear end of each structural member may be fixed to a central portion of the end crossmember of the rear frame.

Three rear load members may connect the main crossmember of the rear frame and the end crossmember of the rear frame. Front ends of the three rear load members may be aligned with the rear ends of the pair of structural members.

One rear load member may connect the main crossmember of the rear frame and the end crossmember of the rear frame. A front end of the rear load member may be fixed to the central portion of the end crossmember of the rear frame, and a rear end of the rear load member may be fixed to a central portion of the main crossmember of the rear frame.

The rear load member may include a pair of front expanded portions symmetrically provided on a front portion thereof and a pair of rear expanded portions symmetrically provided on a rear portion thereof.

A cross-sectional area of the structural member may be greater than a cross-sectional area of the end crossmember of the center frame and a cross-sectional area of the end crossmember of the rear frame.

The structural member may be thicker than the end crossmember of the center frame and the end crossmember of the rear frame.

A top surface of the structural member may be flush with a top surface of the end crossmember of the center frame and a top surface of the end crossmember of the rear frame. A bottom surface of the structural member may be located lower than a bottom surface of the end crossmember of the center frame and a bottom surface of the end crossmember of the rear frame.

The vehicle floor frame may further include a front reinforcement fixed to the bottom surface of the end crossmember of the center frame. The front reinforcement may be aligned with the front end of each of the pair of structural members.

A bottom surface of the front reinforcement may be flush with the bottom surface of each of the pair of structural members.

The vehicle floor frame may further include a rear reinforcement fixed to the bottom surface of the end crossmember of the rear frame. The rear reinforcement may be aligned with the rear end of each of the pair of structural members.

A bottom surface of the rear reinforcement may be flush with the bottom surface of each of the pair of structural members.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 illustrates a perspective view of a vehicle floor frame according to an exemplary embodiment of the present disclosure;

FIG. 2 illustrates a bottom perspective view of the vehicle floor frame, which is viewed in a direction of arrow A illustrated in FIG. 1;

FIG. 3 illustrates an enlarged view of connections of a pair of structural members, a reinforcing member, front load members, and rear load members in the vehicle floor frame illustrated in FIG. 2;

FIG. 4 illustrates the distribution of a load in the vehicle floor frame illustrated in FIGS. 1 to 3;

FIG. 5 illustrates a perspective view of a vehicle floor frame according to another exemplary embodiment of the present disclosure;

FIG. 6 illustrates a bottom perspective view of the vehicle floor frame, which is viewed in a direction of arrow B illustrated in FIG. 5;

FIG. 7 illustrates an enlarged view of connections of a pair of structural members, a reinforcing member, a front load member, and a rear load member in the vehicle floor frame illustrated in FIG. 6; and

FIG. 8 illustrates the distribution of a load in the vehicle floor frame illustrated in FIGS. 5 to 7.

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence, order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

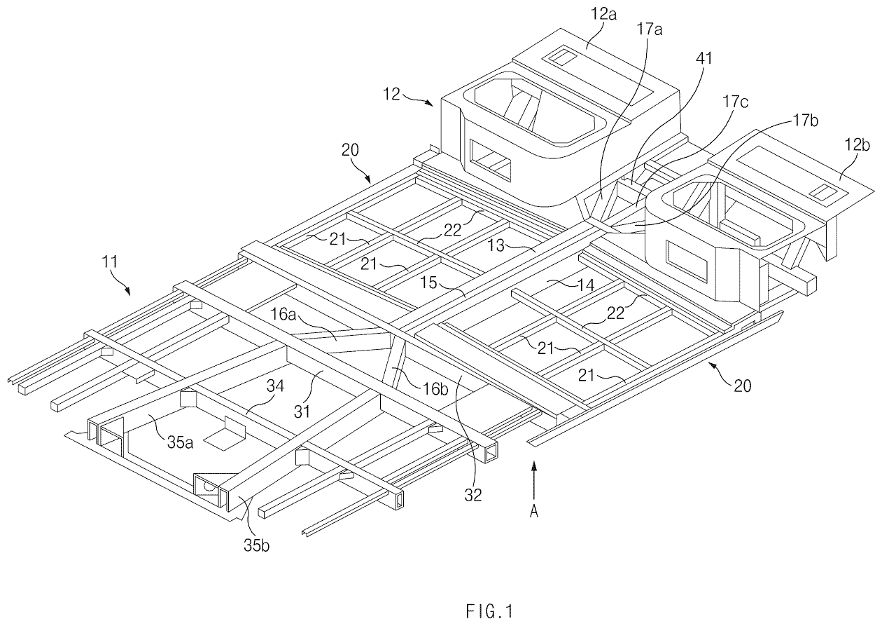

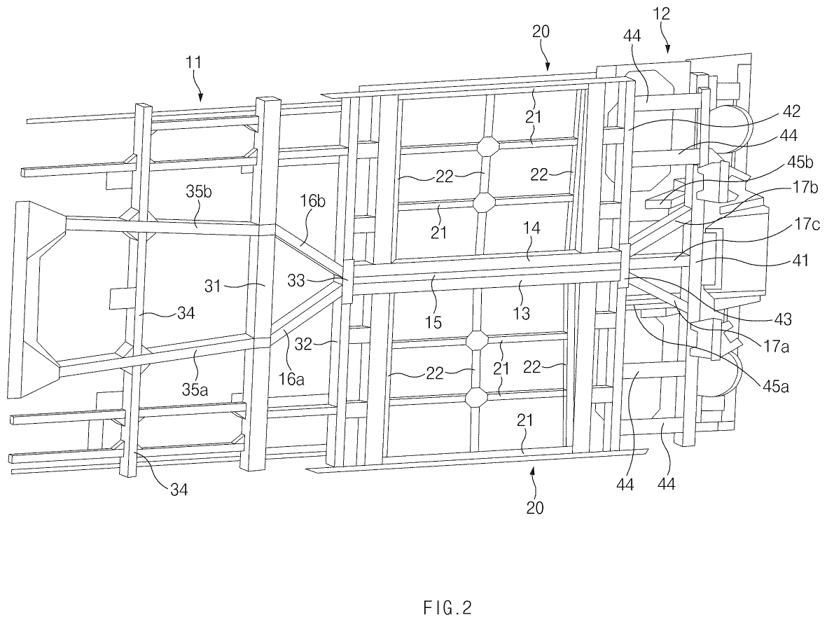

Referring to FIGS. 1 and 2, a vehicle floor frame according to an exemplary embodiment of the present disclosure may include a center frame 11, a rear frame 12 located behind the center frame 11, and a connection unit connecting the center frame 11 and the rear frame 12.

Referring to FIGS. 1 and 2, the center frame 11 may include a main crossmember 31, an end crossmember 32 located behind the main crossmember 31, and a front crossmember 34 located in front of the main crossmember 31.

The main crossmember 31, the end crossmember 32, and the front crossmember 34 may extend in a width direction of the vehicle. The main crossmember 31 may be a structural member stably withstanding a load applied to the center frame 11, and stiffness of the main crossmember 31 may be higher than stiffness of the other members. The end crossmember 32 may be located at a rear edge of the center frame 11.

A pair of diagonal members 35a and 35b may be connected to the main crossmember 31, and the pair of diagonal members 35a and 35b may be symmetrical with respect to a central longitudinal axis of the vehicle floor frame. The pair of diagonal members 35a and 35b may be inclined to the central longitudinal axis of the vehicle floor frame at a predetermined angle. The pair of diagonal members 35a and 35b may be connected to intersect with the front crossmember 34. A rear end of each of the diagonal members 35a and 35b may be fixed to the main crossmember 31 using fasteners, welding, and/or the like. The pair of diagonal members 35a and 35b may include a first diagonal member 35a facing the left side of the vehicle and a second diagonal member 35b facing the right side of the vehicle.

In addition, the center frame 11 may further include a plurality of additional longitudinal members and a plurality of additional transverse members connected to the front crossmember 34, the main crossmember 31, and the end crossmember 32. Each additional longitudinal member may extend in a longitudinal direction of the vehicle, and each additional transverse member may extend in the width direction of the vehicle.

Referring to FIG. 2, the rear frame 12 may include a main crossmember 41 and an end crossmember 42 located in front of the main crossmember 41. The main crossmember 41 and the end crossmember 42 may extend in the width direction of the vehicle. The main crossmember 41 may be a structural member stably withstanding a load applied to the rear frame 12, and stiffness of the main crossmember 41 may be higher than stiffness of the other members. The end crossmember 42 may be located at a front edge of the rear frame 12.

Referring to FIG. 2, a pair of side longitudinal members 45a and 45b may be close to the central longitudinal axis of the vehicle floor frame. The pair of side longitudinal members 45a and 45b may connect the main crossmember 41 and the end crossmember 42. Each of the side longitudinal members 45a and 45b may extend in the longitudinal direction of the vehicle.

Referring to FIG. 2, the rear frame 12 may further include a plurality of additional longitudinal members 44 connecting the main crossmember 41 and the end crossmember 42. Each additional longitudinal member 44 may extend in the longitudinal direction of the vehicle. The rear frame 12 may have a pair of rear attachments 12a and 12b attached to a top surface thereof.

The connection unit may include a pair of structural members 13 and 14 connecting a central portion of the center frame 11 and a central portion of the rear frame 12. The pair of structural members 13 and 14 may be aligned with a central longitudinal axis of the center frame 11 and a central longitudinal axis of the rear frame 12, and accordingly the central longitudinal axis of the center frame 11, the central longitudinal axis of the rear frame 12, and the pair of structural members 13 and 14 may be aligned with the central longitudinal axis of the vehicle floor frame. Each of the structural members 13 and 14 may be configured to connect a central portion of the end crossmember 32 of the center frame 11 and a central portion of the end crossmember 42 of the rear frame 12. A front end of each of the structural members 13 and 14 may be fixed to the central portion of the end crossmember 32 of the center frame 11, and a rear end of each of the structural members 13 and 14 may be fixed to the central portion of the end crossmember 42 of the rear frame 12.

A cross-sectional area of each of the structural members 13 and 14 may be greater than a cross-sectional area of the end crossmember 32 of the center frame 11 and a cross-sectional area of the end crossmember 42 of the rear frame 12 so that stiffness of each of the structural members 13 and 14 may be increased, and thus connection stiffness of the center frame 11 and the rear frame 12 may be improved by each of the structural members 13 and 14.

The pair of structural members 13 and 14 may include a first structural member 13 facing the left side of the vehicle and a second structural member 14 facing the right side of the vehicle. The first structural member 13 and the second structural member 14 may be spaced apart from each other by a predetermined gap.

According to an exemplary embodiment of the present disclosure, the connection unit may further include a reinforcing member 15 interposed between the pair of structural members 13 and 14. Both side surfaces of the reinforcing member 15 may be fixed to the pair of structural members 13 and 14 by welding and/or the like, respectively. A front end of the reinforcing member 15 may be fixed to the central portion of the end crossmember 32 of the center frame 11, and a rear end of the reinforcing member 15 may be fixed to the central portion of the end crossmember 42 of the rear frame 12. The pair of structural members 13 and 14 and the reinforcing member 15 may be aligned with the central longitudinal axis of the vehicle floor frame. Thus, the pair of structural members 13 and 14 and the reinforcing member 15 may connect the center frame 11 and the rear frame 12 along the central longitudinal axis of the vehicle floor frame so that stiffness of the vehicle floor frame may be improved.

According to an exemplary embodiment, each of the structural members 13 and 14 and the reinforcing member 15 may be thicker than the end crossmember 32 of the center frame 11 and the end crossmember 42 of the rear frame 12. Each of the structural members 13 and 14 and the reinforcing member 15 may have the same thickness.

Referring to FIG. 1, a top surface of each of the structural members 13 and 14 and a top surface of the reinforcing member 15 may be flush with a top surface of the end crossmember 32 of the center frame 11 and a top surface of the end crossmember 42 of the rear frame 12.

Referring to FIG. 2, a bottom surface of each of the structural members 13 and 14 and a bottom surface of the reinforcing member 15 may be located lower than a bottom surface of the end crossmember 32 of the center frame 11 and a bottom surface of the end crossmember 42 of the rear frame 12.

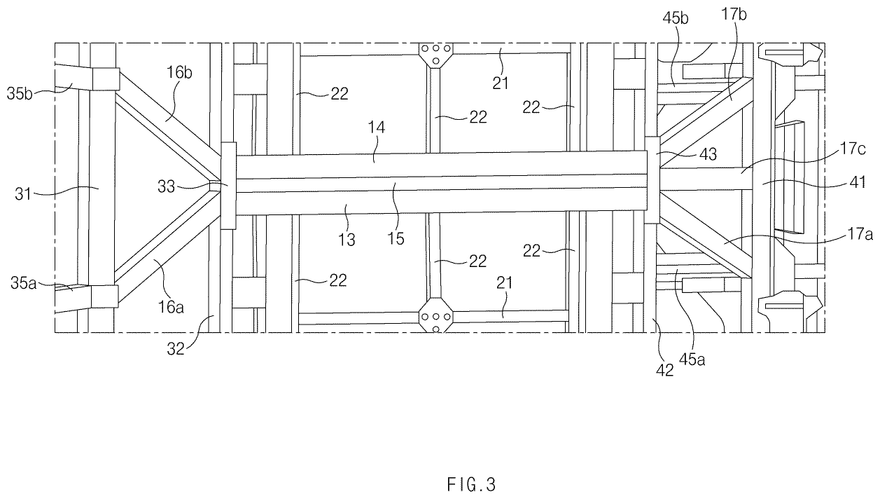

Referring to FIGS. 2 to 4, the vehicle floor frame may further include a front reinforcement 33 aligned with the front end of each of the pair of structural members 13 and 14 and the front end of the reinforcing member 15. The front reinforcement 33 may be fixed to the bottom surface of the end crossmember 32 of the center frame 11 by welding. A bottom surface of the front reinforcement 33 may be flush with the bottom surface of each of the structural members 13 and 14 and the bottom surface of the reinforcing member 15.

Referring to FIGS. 2 to 4, the vehicle floor frame may further include a rear reinforcement 43 aligned with the rear end of each of the pair of structural members 13 and 14 and the rear end of the reinforcing member 15. The rear reinforcement 43 may be fixed to the bottom surface of the end crossmember 42 of the rear frame 12 by welding. A bottom surface of the rear reinforcement 43 may be flush with the bottom surface of each of the structural members 13 and 14 and the bottom surface of the reinforcing member 15.

The vehicle floor frame according to an exemplary embodiment of the present disclosure may include front load members 16a and 16b connecting the center frame 11 and a front portion of the connection unit, and accordingly the front load members 16a and 16b may be configured to transfer a load from the center frame 11 to the connection unit. Referring to FIGS. 1 to 4, the two front load members 16a and 16b may be configured to connect the main crossmember 31 of the center frame 11 and the end crossmember 32 of the center frame 11. The two front load members 16a and 16b may be configured to transfer the load applied to the center frame 11 to the connection unit. The two front load members 16a and 16b may include a first front load member 16a facing the left side of the vehicle and a second front load member 16b facing the right side of the vehicle.

A front end of the first front load member 16a may be fixed to a left portion of the main crossmember 31 using fasteners, welding, and/or the like, and a rear end of the first front load member 16a may be fixed to the central portion of the end crossmember 32 using fasteners, welding, and/or the like. A front end of the second front load member 16b may be fixed to a right portion of the main crossmember 31 using fasteners, welding, and/or the like, and a rear end of the second front load member 16b may be fixed to the central portion of the end crossmember 32 using fasteners, welding, and/or the like. The front end of the first front load member 16a may be aligned with the rear end of the first diagonal member 35a, and the front end of the second front load member 16b may be aligned with the rear end of the second diagonal member 35b. The front end of the first front load member 16a and the front end of the second front load member 16b may be spaced apart from each other in a longitudinal direction of the main crossmember 31, and the rear end of the first front load member 16a and the rear end of the second front load member 16b may be aligned with the front end of each of the pair of structural members 13 and 14 and the front end of the reinforcing member 15.

The rear end of the first front load member 16a and the rear end of the second front load member 16b may be adjacent to each other at the central portion of the end crossmember 32 so that the two front load members 16a and 16b may form a V-like shape.

The vehicle floor frame according to an exemplary embodiment of the present disclosure may include rear load members 17a, 17b, and 17c connecting the rear frame 12 and a rear portion of the connection unit, and the rear load members 17a, 17b, and 17c may be configured to transfer a load from the connection unit to the rear frame 12. Referring to FIGS. 1 to 4, the three rear load members 17a, 17b, and 17c may be configured to connect the main crossmember 41 and the end crossmember 42. The three rear load members 17a, 17b, and 17c may be configured to transfer the load applied to the structural members 13 and 14 and the reinforcing member 15 to the rear frame 12.

The three rear load members 17a, 17b, and 17c may include a first rear load member 17a facing the left side of the vehicle, a second rear load member 17b facing the right side of the vehicle, and a third rear load member 17c located between the first rear load member 17a and the second rear load member 17b.

A front end of the first rear load member 17a may be fixed to the central portion of the end crossmember 42 using fasteners, welding, and/or the like, and a rear end of the first rear load member 17a may be fixed to a left portion of the main crossmember 41 using fasteners, welding, and/or the like. A front end of the second rear load member 17b may be fixed to the central portion of the end crossmember 42 using fasteners, welding, and/or the like, and a rear end of the second rear load member 17b may be fixed to a right portion of the main crossmember 41 using fasteners, welding, and/or the like.

The front end of the first rear load member 17a and the front end of the second rear load member 17b may be adjacent to each other at the central portion of the end crossmember 42, and the rear end of the first rear load member 17a and the rear end of the second rear load member 17b may be spaced apart from each other in a longitudinal direction of the main crossmember 41 so that the first rear load member 17a and the second rear load member 17b may form a V-like shape.

A front end of the third rear load member 17c may be fixed to the central portion of the end crossmember 42 using fasteners, welding, and/or the like, and the front end of the third rear load member 17c may be located between the front end of the first rear load member 17a and the front end of the second rear load member 17b at the central portion of the end crossmember 42. A rear end of the third rear load member 17c may be fixed to the central portion of the main crossmember 41 using fasteners, welding, and/or the like. The third rear load member 17c may be aligned with the central longitudinal axis of the rear frame 12, and the third rear load member 17c may be aligned with the reinforcing member 15 along the central longitudinal axis of the vehicle floor frame.

A pair of support frames 20 may be connected to the pair of structural members 13 and 14, respectively. The pair of support frames 20 may be arranged symmetrically with respect to the central longitudinal axis of the vehicle floor frame, and the pair of support frames 20 may be disposed between the center frame 11 and the rear frame 12. Accordingly, a pair of ramps may be provided on the pair of support frames 20. Each support frame 20 may include a plurality of longitudinal members 21 extending in the longitudinal direction of the vehicle and a plurality of transverse members 22 extending in the width direction of the vehicle. The transverse members 22 of each support frame 20 may be fixed to the corresponding structural members 13 and 14 by welding and/or the like.

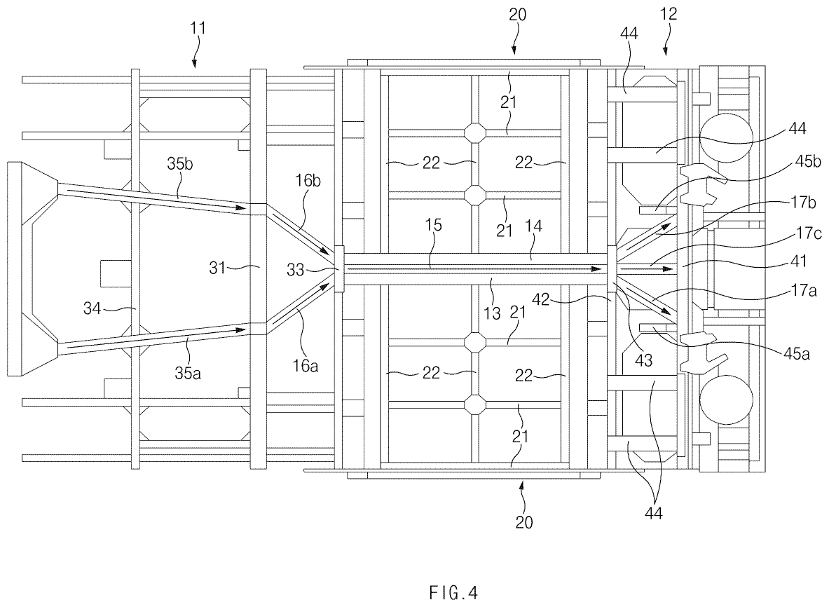

Referring to FIG. 4, a torsional load applied to the center frame 11 may be transferred to the main crossmember 31 through the pair of diagonal members 35a and 35b, and the torsional load may be transferred from the main crossmember 31 to the connection unit (the pair of structural members 13 and 14 and the reinforcing member 15) through the two front load members 16a and 16b. The load transferred to the pair of structural members 13 and 14 and the reinforcing member 15 may be uniformly distributed in three directions through the three rear load members 17a, 17b, and 17c and transferred to the rear frame 12.

As described above, the pair of structural members 13 and 14 and the reinforcing member 15 may be connected to the center frame 11 through the two front load members 16a and 16b, and the pair of structural members 13 and 14 and the reinforcing member 15 may be connected to the rear frame 12 through the three rear load members 17a, 17b, and 17c so that the load may be uniformly distributed through the two front load members 16a and 16b, the pair of structural members 13 and 14, the reinforcing member 15, and the three rear load members 17a, 17b, and 17c, and thus stress generated in the vehicle floor frame according to the exemplary embodiment of the present disclosure may be reduced by approximately 31% compared to that generated in a vehicle floor frame according to the related art.

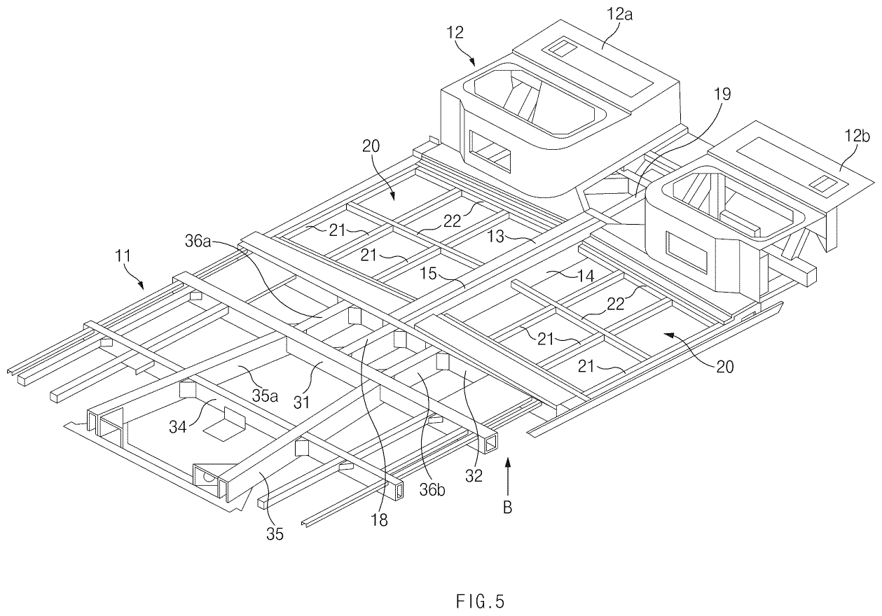

FIGS. 5 to 8 illustrate a vehicle floor frame according to another exemplary embodiment of the present disclosure.

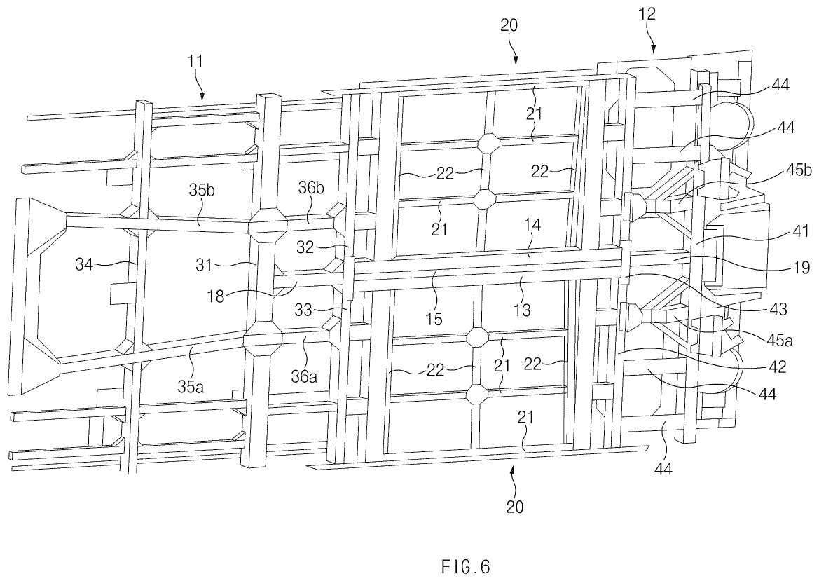

Referring to FIGS. 5 and 6, a vehicle floor frame according to another exemplary embodiment of the present disclosure may include a front load member 18 configured to transfer a load from the center frame 11 to the connection unit (the pair of structural members 13 and 14 and the reinforcing member 15). One front load member 18 may be configured to connect the main crossmember 31 and the end crossmember 32. The front load member 18 may extend in the central longitudinal axis of the vehicle floor frame, and the front load member 18 may be aligned with the pair of structural members 13 and 14 and the reinforcing member 15. A front end of the front load member 18 may be fixed to the central portion of the main crossmember 31 using fasteners, welding, and/or the like, and a rear end of the front load member 18 may be fixed to the central portion of the end crossmember 32 using fasteners, welding, and/or the like.

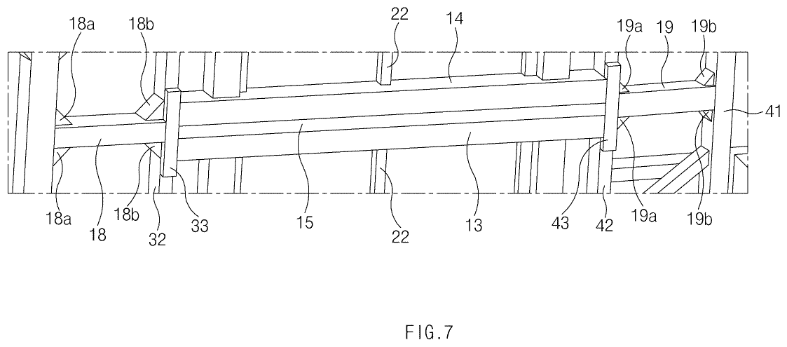

Referring to FIG. 7, the front load member 18 may include a pair of front expanded portions 18a symmetrically provided on a front portion thereof and a pair of rear expanded portions 18b symmetrically provided on a rear portion thereof. The pair of front expanded portions 18a may be symmetrically provided on the front portion of the front load member 18 so that a contact area between the front portion of the front load member 18 and the main crossmember 31 may be relatively increased, and accordingly the front portion of the front load member 18 may be more firmly fixed to the main crossmember 31. The pair of rear expanded portions 18b may be symmetrically provided on the rear portion of the front load member 18 so that a contact area between the rear portion of the front load member 18 and the end crossmember 32 may be relatively increased, and accordingly the rear portion of the front load member 18 may be more firmly fixed to the end crossmember 32.

Referring to FIGS. 5 and 6, the center frame 11 may further include a pair of side longitudinal members 36a and 36b symmetrically provided on both sides of the front load member 18, and the pair of side longitudinal members 36a and 36b may be configured to connect the main crossmember 31 and the end crossmember 32. Each of the side longitudinal members 36a and 36b may extend in the longitudinal direction of the vehicle. The pair of side longitudinal members 36a and 36b may include a first side longitudinal member 36a facing the left side of the vehicle and a second side longitudinal member 36b facing the right side of the vehicle. The first side longitudinal member 36a may be aligned with the first diagonal member 35a, and the second side longitudinal member 36b may be aligned with the second diagonal member 35b.

Referring to FIGS. 5 and 6, the vehicle floor frame according to another exemplary embodiment of the present disclosure may include a rear load member 19 configured to transfer a load from the connection unit (the pair of structural members 13 and 14 and the reinforcing member 15) to the rear frame 12. One rear load member 19 may be configured to connect the main crossmember 41 and the end crossmember 42. The rear load member 19 may extend in the central longitudinal axis of the vehicle floor frame, and the rear load member 19 may be aligned with the pair of structural members 13 and 14 and the reinforcing member 15. A front end of the rear load member 19 may be fixed to the central portion of the end crossmember 42 using fasteners, welding, and/or the like, and a rear end of the rear load member 19 may be fixed to the central portion of the main crossmember 41 using fasteners, welding, and/or the like.

Referring to FIG. 7, the rear load member 19 may include a pair of front expanded portions 19a symmetrically provided on a front portion thereof and a pair of rear expanded portions 19b symmetrically provided on a rear portion thereof. The pair of front expanded portions 19a may be symmetrically provided on the front portion of the rear load member 19 so that a contact area between the front portion of the rear load member 19 and the end crossmember 42 may be relatively increased, and accordingly the front portion of the rear load member 19 may be more firmly fixed to the end crossmember 42. The pair of rear expanded portions 19b may be symmetrically provided on the rear portion of the rear load member 19 so that a contact area between the rear portion of the rear load member 19 and the main crossmember 41 may be relatively increased, and accordingly the rear portion of the rear load member 19 may be more firmly fixed to the main crossmember 41.

Referring to FIGS. 5 and 6, the pair of side longitudinal members 45a and 45b may be configured to connect the main crossmember 41 and the end crossmember 42. The pair of side longitudinal members 45a and 45b may be symmetrically provided on both left and right sides of the rear load member 19. Each of the side longitudinal members 45a and 45b may extend in the longitudinal direction of the vehicle.

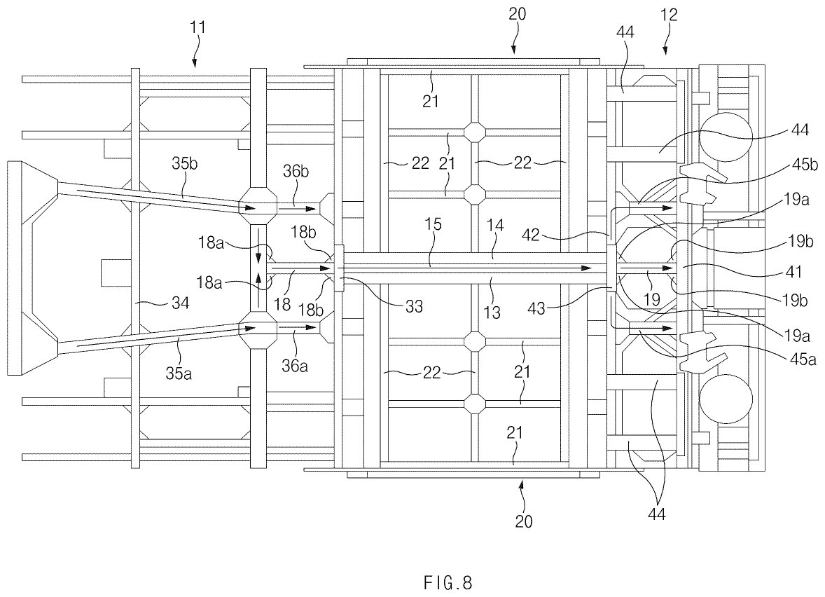

Referring to FIG. 8, a torsional load applied to the center frame 11 may be transferred to the main crossmember 31 through the pair of diagonal members 35a and 35b, and the torsional load may be transferred from the main crossmember 31 to the connection unit (the pair of structural members 13 and 14 and the reinforcing member 15) through the front load member 18 and the pair of side longitudinal members 36a and 36b. The load applied to the connection unit (the pair of structural members 13 and 14 and the reinforcing member 15) may be uniformly distributed in three directions through the rear load member 19 and the pair of side longitudinal members 45a and 45b and transferred to the rear frame 12.

As described above, the pair of structural members 13 and 14 and the reinforcing member 15 may be connected to the center frame 11 through one front load member 18, and the pair of structural members 13 and 14 and the reinforcing member 15 may be connected to the rear frame 12 through one rear load member 19 so that the load may be uniformly distributed through one front load member 18, the pair of side longitudinal members 36a and 36b, the pair of structural members 13 and 14, the reinforcing member 15, one rear load member 19, and the pair of side longitudinal members 45a and 45b. Thus, stress generated in the vehicle floor frame according to the exemplary embodiment of the present disclosure may be reduced by approximately 31% compared to that generated in the related art vehicle floor frame.

The other elements/configurations of the vehicle floor frame in this exemplary embodiment may be the same as or similar to those illustrated in FIGS. 1 to 4.

As set forth above, the vehicle floor frame according to exemplary embodiments of the present disclosure may be designed to have the connection unit directly connecting the center frame and the rear frame along the central longitudinal axis of the vehicle floor frame so that the stiffness of the vehicle floor frame may be improved. The pair of support frames may be connected to the pair of structural members, respectively, so that the pair of ramps may be mounted on the pair of support frames, respectively.

According to exemplary embodiments of the present disclosure, the front portion of the connection unit may be connected to the center frame through the front load member(s), and the rear portion of the connection unit may be connected to the rear frame through the rear load member(s) so that the load may be uniformly distributed through the front load member(s), the connection unit, and the rear load member(s), and thus the stress generated in the vehicle floor frame may be significantly reduced compared to that generated in the related art vehicle floor frame.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle floor frame comprising:
a center frame;
a rear frame disposed behind the center frame;
a connection unit connecting the center frame and the rear frame;
a pair of support frames disposed on both sides of the connection unit between the center frame and the rear frame;
a front load member connecting the center frame and a front portion of the connection unit; and
a rear load member connecting the rear frame and a rear portion of the connection unit.

2. The vehicle floor frame according to claim 1, wherein the connection unit comprises a pair of structural members aligned with a central longitudinal axis of the center frame and a central longitudinal axis of the rear frame.

3. The vehicle floor frame according to claim 2, wherein the connection unit further comprises a reinforcing member interposed between the pair of structural members.

4. The vehicle floor frame according to claim 2, wherein the pair of support frames are connected to the pair of structural members, respectively.

5. The vehicle floor frame according to claim 2, wherein:
the center frame comprises a main crossmember and an end crossmember disposed behind the main crossmember; and
a front end of each structural member is fixed to a central portion of the end crossmember of the center frame.

6. The vehicle floor frame according to claim 5, wherein:
two front load members connect the main crossmember of the center frame and the end crossmember of the center frame; and
rear ends of the two front load members are aligned with the front ends of the pair of structural members.

7. The vehicle floor frame according to claim 5, wherein:
one front load member connects the main crossmember of the center frame and the end crossmember of the center frame;
a front end of the front load member is fixed to a central portion of the main crossmember of the center frame; and
a rear end of the front load member is fixed to the central portion of the end crossmember of the center frame.

8. The vehicle floor frame according to claim 7, wherein the front load member comprises:
a pair of front expanded portions symmetrically disposed on a front portion thereof; and
a pair of rear expanded portions symmetrically disposed on a rear portion thereof.

9. A vehicle floor frame comprising:
a center frame comprising a main crossmember and an end crossmember disposed behind the main crossmember;
a rear frame disposed behind the center frame and comprising a main crossmember and an end crossmember disposed in front of the main crossmember;
a connection unit connecting the center frame and the rear frame, wherein the connection unit comprises a pair of structural members aligned with a central longitudinal axis of the center frame and a central longitudinal axis of the rear frame, and wherein a front end of each structural member is fixed to a central portion of the end crossmember of the center frame and a rear end of each structural member is fixed to a central portion of the end crossmember of the rear frame;
a pair of support frames disposed on both sides of the connection unit between the center frame and the rear frame;
a front load member connecting the center frame and a front portion of the connection unit; and
a rear load member connecting the rear frame and a rear portion of the connection unit.

10. The vehicle floor frame according to claim 9, wherein:
three rear load members connect the main crossmember of the rear frame and the end crossmember of the rear frame; and
front ends of the three rear load members are aligned with the rear ends of the pair of structural members.

11. The vehicle floor frame according to claim 9, wherein:
one rear load member connects the main crossmember of the rear frame and the end crossmember of the rear frame;
a front end of the rear load member is fixed to the central portion of the end crossmember of the rear frame; and
a rear end of the rear load member is fixed to a central portion of the main crossmember of the rear frame.

12. The vehicle floor frame according to claim 11, wherein the rear load member comprises:
a pair of front expanded portions symmetrically disposed on a front portion thereof; and
a pair of rear expanded portions symmetrically disposed on a rear portion thereof.

13. The vehicle floor frame according to claim 9, wherein a cross-sectional area of each structural member is greater than a cross-sectional area of the end crossmember of the center frame and a cross-sectional area of the end crossmember of the rear frame.

14. The vehicle floor frame according to claim 9, wherein each structural member is thicker than the end crossmember of the center frame and the end crossmember of the rear frame.

15. The vehicle floor frame according to claim 14, wherein:
a top surface of the structural member is flush with a top surface of the end crossmember of the center frame and a top surface of the end crossmember of the rear frame; and
a bottom surface of the structural member is located lower than a bottom surface of the end crossmember of the center frame and a bottom surface of the end crossmember of the rear frame.

16. The vehicle floor frame according to claim 15, further comprising a front reinforcement fixed to the bottom surface of the end crossmember of the center frame, wherein the front reinforcement is aligned with the front end of each structural member of the pair of structural members.

17. The vehicle floor frame according to claim 16, wherein a bottom surface of the front reinforcement is flush with the bottom surface of each structural member of the pair of structural members.

18. The vehicle floor frame according to claim 15, further comprising a rear reinforcement fixed to the bottom surface of the end crossmember of the rear frame, wherein the rear reinforcement is aligned with the rear end of each structural member of the pair of structural members.

19. The vehicle floor frame according to claim 18, wherein a bottom surface of the rear reinforcement is flush with the bottom surface of each structural member of the pair of structural members.

20. A vehicle floor frame comprising:
a center frame comprising a main crossmember and an end crossmember disposed behind the main crossmember;
a rear frame disposed behind the center frame;
a connection unit connecting the center frame and the rear frame, the connection unit comprising:
a pair of structural members aligned with a central longitudinal axis of the center frame and a central longitudinal axis of the rear frame, wherein a front end of each structural member is fixed to a central portion of the end crossmember of the center frame; and
a reinforcing member interposed between the pair of structural members;
a pair of support frames disposed on both sides of the connection unit between the center frame and the rear frame, wherein the pair of support frames are connected to the pair of structural members, respectively;
a front load member connecting the main crossmember of the center frame and the end crossmember of the center frame, wherein the front load member comprises:
a pair of front expanded portions symmetrically disposed on a front portion thereof; and
a pair of rear expanded portions symmetrically disposed on a rear portion thereof; and
a rear load member connecting the rear frame and a rear portion of the connection unit.
